(19) United States
(12) Patent Application Publication
(10) Pub. No.: US 2012/0143573 A1
(43) Pub. Date: Jun. 7, 2012

(54) Method for Tracking Detail-Preserving Fully-Eulerian Interface

(76) Inventors: Hyeong-Seok KO, Seoul (KR); Nambin Heo, Seoul (KR)

(21) Appl. No.: 12/960,335

(22) Filed: Dec. 3, 2010

Related U.S. Application Data
(60) Provisional application No. 61/418,519, filed on Dec. 1, 2010.

(51) Int. Cl. G06F 17/11

(52) U.S. Cl. 703/2

(57) ABSTRACT

A method for tracking fully-Eulerian interface is provided, which preserves the fine details of liquids. Unlike existing Eulerian methods, the method shows good mass conservation even though it does not employ conventional Lagrangian elements. In addition, it handles complex merging and splitting of interfaces robustly due to the implicit representation. To model the interface more accurately, a high order polynomial reconstruction of the signed distance function is utilized based on a number of sub-grid quadrature points. By combining this accurate polynomial representation with a high-order re-initialization method, the method preserves the detailed structures of the interface. Moreover, the method is simple to implement, unconditionally stable, and is suitable for parallel computing environments.

### BACKGROUND OF THE INVENTION

The present invention relates to a method for tracking detail-preserving fully-Eulerian interface.

### SUMMARY OF THE INVENTION

The present invention contrives to solve the disadvantages of the prior art.

An aspect of the invention provides a method for tracking detail-preserving fully-Eulerian interface.

The method for tracking fully-Eulerian interface comprises steps of:

representing a liquid volume using a spectrally refined level set (SRL) surface represented by a level set function, wherein the SRL provides a plurality of fixed grid points near a phase interface of the liquid, and provides a predetermined number of sub-grid quadrature points;

solving an advection equation for evolving the phase interface in time;

transporting the level set function using a reconstructed high-order polynomials;

re-distancing the level set function using a PDE-based re-distancing equation; and
displaying on a computer display a portion of the liquid volume including the phase interface represented by the transported level set.

The sub-grid quadrature points may comprise Gauss-Lobatto quadrature points.

The number of the predetermined number of sub-grid quadrature points may comprise three (3), five (5), seven (7), and nine (9).

The phase interface may be evolved by a velocity field.

The level set function, φ, may be represented as a signed distance function such that |∇φ|=1 and the phase interface may be defined as φ=0.

The advection equation may be given by

φₜ+u·∇φ=0 (1)

The step for representing may comprise steps for:

constructing a high-order polynomial description of the level set function for each cell; and

determining interpolation weights for a given point using a classical Lagrange polynomial.

A multi-dimensional Lagrange interpolation may be performed by a dimensional splitting method.

The dimensional splitting method may be given by

$$\begin{matrix}{φ}_{i , j , k} ( x , y , z ) = {\sum }_{p = 0}^{N - 1} [ {w}^{p} ( {x}^{′} ) {\sum }_{q = 0}^{N - 1} [ {w}^{q} ( {y}^{′} ) {\sum }_{r = 0}^{N - 1} {w}^{r} ( {z}^{′} ) {φ}_{i , j , k}^{p , q , r} ] ] & ( 2 ) \\ ( {w}^{α} ( r ) = \frac{{\prod }_{β = 0 , β \neq α}^{N - 1} ( r - {r}_{β} )}{{\prod }_{β = 0 , β \neq α}^{N - 1} ( {r}_{α} - {r}_{β} )} ) & ( 3 ) \\ ( {x}^{′} = \frac{x - {x}_{i}}{{x}_{i + 1} - {x}_{i}} , {y}^{′} = \frac{y - {y}_{i}}{{y}_{i + 1} - {y}_{i}} , {z}^{′} = \frac{z - {z}_{i}}{{z}_{i + 1} - {z}_{i}} ) & ( 4 )\end{matrix}$$

The step for transporting may comprise a step for limiting the interpolation when the interpolated result is larger or smaller than a maximum or minimum of sub-grid values.

The PDE-based re-distancing equation may be given by

φₜ+S(φ₀)(|∇φ|−1)=0 (6)

The step for re-distancing may comprise a step for performing high-order derivative computations are performed only in a narrow band that contains the sub-grid quadrature points.

Outside of the narrow, a band simple first-order upwind method may be used.

The advantages of the present invention are: (1) the method simulates the phase interface of liquids preserving fine details of liquids; and (2) the method is simple to implement, stable, and suitable for parallel computing environment.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1(a) is a Distribution of Gauss-Lobatto quadrature points based on Legendre polynomials (N=3, 5, 7, 9 for 1D and N=5 for 2D), and FIG. 1(b) is the sub-grid quadrature points provided only near the interface;

FIG. 2 is a comparison of re-initialization methods, where the reinitialization was performed at every time step, showing the results after 5 rotations on 101 SRL grids, in which the disk completed each revolution in 628 time steps: (a) Direct re-distancing based on an extracted mesh from the refined grid, (b) PDE-based re-distancing based on 3rd-order variable WENO, (c) PDE-based re-distancing based on 5th-order variable WENO;

FIG. 3 is a comparison of re-initialization methods, where The reinitialization is performed infrequently and the graph plots the volume errors for each re-initialization method in the experiments which rotate a bunny-shaped model in a 128³ SRL grid; and

FIG. 4 a flow-chart showing a method according to an embodiment of the invention.

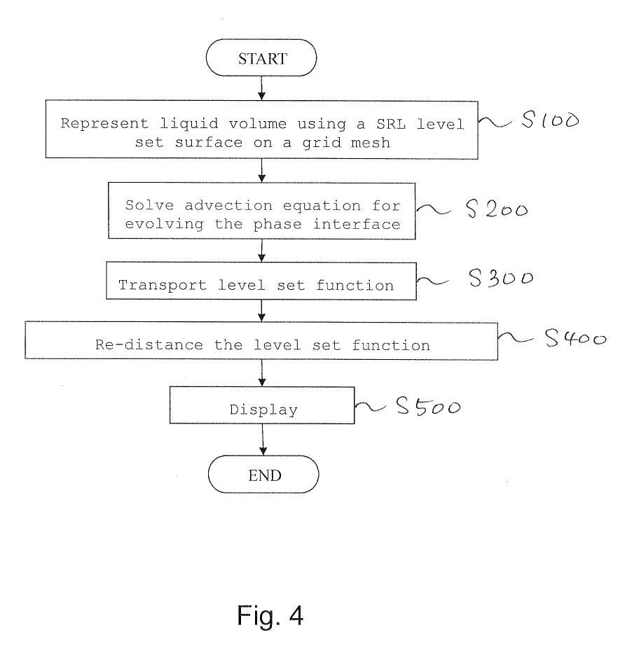

### DETAILED DESCRIPTION EMBODIMENTS OF THE INVENTION

U.S. Provisional Application No. 61/418,519 was filed on Dec. 1, 2010 for an invention entitled “Method for Tracking Detail-Preserving Fully-Eulerian Interface.” The disclosures of the application are incorporated by reference as if fully set forth herein.

### 1. Introduction

Interface tracking has long been an important issue in a wide variety of areas, such as computer graphics, image processing, and computational fluid dynamics. Interfaces usually experience complex movements such as merging or pinching. As such, tracking interfaces can be a challenging task. In general, there are two important aspects that are closely related to the quality of interface tracking algorithms: topology change and volume conservation. Interface tracking methods are generally categorized as either Eulerian or Lagrangian. Eulerian methods are typically good for handling complex topological changes. However, they tend to suffer from excessive numerical diffusion, which leads to disappearance of detailed structures. In contrast, Lagrangian methods show good mass conservation due to the preservation of characteristic information. However, they usually require complex re-meshing procedures to treat topological changes.

To get over the above weaknesses associated with the Eulerian and Lagrangian methods, several hybrid methods have been developed [Enright et al. 2002a; Mihalef et al. 2007]. Through the use of advected particles, those methods could produce impressive results in terms of mass conservation. However, the methods could experience some aliasing artifacts [Bargteil et al. 2006] and physical inconsistency problems. For example, when the characteristics in a given region are merged, some particles need to be deleted because they represent the situation differently from the Eulerian grids. Although several treatments have been developed [Enright et al. 2003; Rasmussen et al. 2004; Losasso et al. 2006], a completely satisfactory solution has not yet been proposed. Recently, Wang et al. [2009] also pointed out that accuracy of the particle level set method is sensitive to the particle reseeding strategy which varies for different problems.

In this invention, we introduce a fully-Eulerian interface tracking framework that can preserve fine details of the interface. In contrast to existing Eulerian frameworks, which suffer from severe mass loss, the proposed scheme exhibits good mass conservation, comparable to that of Lagrangian counterparts. To capture evolving surfaces more accurately, we employ a pseudo-spectral representation of the level set function [Desjardins and Pitsch 2009] that provides a precise sub-grid description of the interface. To prevent destruction of fine surface details during re-initialization, we propose a high-order PDE-based re-initialization method [Osher and Fedkiw 2002] that can be applied to a spectrally refined grid structure. By combining the above techniques, the signed distance property is preserved more accurately and hence small-scale surface details are well preserved without any Lagrangian computational element. We demonstrate our approach with several challenging liquid simulations that generate highly detailed, complex surfaces.

### 2. Related Work

There are three popular frameworks for the interface tracking problem: level set, front tracking, and volume of fluid methods. The level set method [Osher and Sethian 1988; Sethian 1999; Osher and Fedkiw 2002] has the flexibility required for handling complex topological changes, but commonly suffers from volume loss due to numerical diffusion. On the contrary, Lagrangian methods [Brochu and Bridson 2009] successfully conserve mass because they can preserve the flow characteristics. Volume of fluid [Gueyffier et al. 1999] method conserves entire volume explicitly, but calculating geometric quantities is difficult [Enright et al. 2002a].

Enright and colleagues [2002a] proposed a hybrid framework, called the particle level set method, that combines the Eulerian and Lagrangian approaches to achieve effective interface capturing. Recently, Wang et al. [2009] proposed several revisions to the particle level set method to remedy some limitations in the original scheme. As other hybrid approaches, several mesh-based interface tracking frameworks [Wojtan et al. 2009; M″uller 2009] were proposed to overcome the difficulties associated with re-meshing in the front tracking method. Recently, Wojtan et al. [2010] proposed a new re-sampling method for connecting surface features during topological changes to enhance their original mesh-based surface tracking framework [Wojtan et al. 2009]. In addition, semi-Lagrangian countouring method [Bargteil et al. 2006; Chentanez et al. 2007], which utilizes both a Eulerian grid and triangle mesh structure, was developed for accurate computation of the signed distance, thus alleviating the numerical diffusion caused by linear interpolation. To enhance the surface tracking quality, adaptive methods have also been developed, including the octree [Losasso et al. 2004; Kim et al. 2009] and the hierarchical RLE grid [Houston et al. 2006].

Recently, a number of level set methods based on a finite element framework such as the spectral element method [Sussman and Hussaini 2003] or the discontinuous Galerkin method [Marchandise and Remade 2006] are presented. In a similar context, Desjardins and Pitsch proposed a spectrally refined level set (SRL) method to provide a sub-cell representation of the interface through a pseudo-spectral description of the level set function. They demonstrated effectiveness of the proposed method by several experiments including the 2D Zalesak disk and the Enright test. Our work, which has been motivated by Desjardins and Pitsch [2009], suggests an accurate interface tracking framework by combining this pseudo-spectral representation with a high-order re-initialization method [Osher and Fedkiw 2002] which is designed for the SRL grid and further demonstrates the effectiveness of the approach with several challenging three-dimensional liquid simulation experiments that incorporate highly detailed, complex surface geometry.

### 3. Method

In this section, we present a fully-Eulerian interface tracking framework that preserves small details of the interface. Because it does not employ any Lagrangian computational element, it can robustly handle topological changes without any special treatment. Moreover, by utilizing accurate polynomial reconstruction and a high-order PDE-based re-initialization method, the mass conservation quality is comparable to that obtained with Lagrangian frameworks. Furthermore, the proposed approach is well suited to parallel computing environments.

### 3.1 Pseudo-Spectral Refinement of the Level Set

In this work, we employ the level set method, which tracks the phase interface in the form of an iso-contour in a higher dimensional space. The level set function φ is usually represented as a signed distance function such that |∇φ|=1, and the interface is defined as φ=0. From the signed distance property, various geometric quantities such as normal n=∇φ/|∇φ| and curvature κ=∇·n can be easily computed.

The interface is evolved in time by a given velocity field u according to the well-known advection equation

φₜ+u·∇φ=0. (1)

The main difficulty associated with evolving the level set function is numerical diffusion, which tends to make small-scale droplets disappear and cause the overall liquid volume to decrease. These phenomena, especially the disappearance of small scale interfacial features, are visually undesirable.

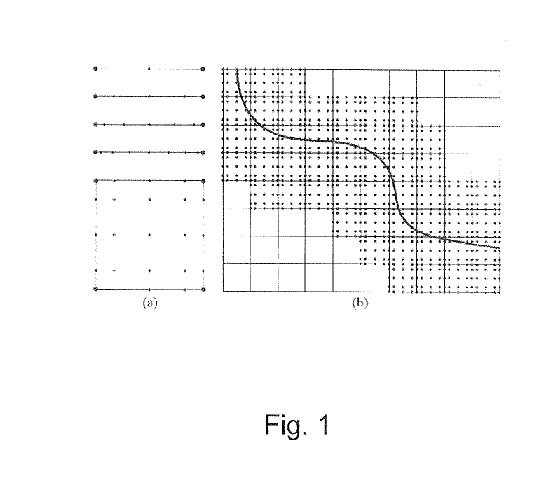

To preserve the fine details of the liquid phase, we deploy a spectrally refined level set (SRL) method [Desjardins and Pitsch 2009] that provides an accurate description of the interface. Instead of using particles or meshes to provide sub-cell representations, SRL introduces a number of fixed grid points near the interface. Using these pre-assigned sub-cell computational elements, an accurate polynomial reconstruction of the signed distance function becomes possible. To avoid Runge phenomena [Press et al. 2007], SRL utilizes Gauss-Lobatto quadrature points as shown in FIG. 1.

After quadrature points have been properly defined (r₀=0, r₁, . . . , r_{N-1}=1), we can construct a high-order polynomial description of the level set function for each cell. For any given point, the interpolation weights are determined using the classical Lagrange polynomial. The multi-dimensional Lagrange interpolation can also be performed efficiently by the dimensional splitting method, as given below.

$$\begin{matrix}{φ}_{i , j , k} ( x , y , z ) = {\sum }_{p = 0}^{N - 1} [ {w}^{p} ( {x}^{′} ) {\sum }_{q = 0}^{N - 1} [ {w}^{q} ( {y}^{′} ) {\sum }_{r = 0}^{N - 1} {w}^{r} ( {z}^{′} ) {φ}_{i , j , k}^{p , q , r} ] ] & ( 2 ) \\ ( {w}^{α} ( r ) = \frac{{\prod }_{β = 0 , β \neq α}^{N - 1} ( r - {r}_{β} )}{{\prod }_{β = 0 , β \neq α}^{N - 1} ( {r}_{α} - {r}_{β} )} ) & ( 3 ) \\ ( {x}^{′} = \frac{x - {x}_{i}}{{x}_{i + 1} - {x}_{i}} , {y}^{′} = \frac{y - {y}_{i}}{{y}_{i + 1} - {y}_{i}} , {z}^{′} = \frac{z - {z}_{i}}{{z}_{i + 1} - {z}_{i}} ) & ( 4 )\end{matrix}$$

To save computational resources, the quadrature points are seeded only near the interface as shown in FIG. 1 (The bandwidth is usually 3-5.). Due to the narrow band refinement, it requires approximately one order of magnitude less memory compared to a regular grid with the same effective resolution. In addition, for the case where the number of quadrature points is five (i.e., N=5), the memory usage is similar to that in the particle level set method (in 3D, (5−1)3=64, because sub-grid quadrature points on the cell boundaries are shared.)

### 3.2 Advection Based on Polynomial Reconstruction

By using the reconstructed high-order polynomials, we can transport the level set function based on a semi-Lagrangian method [Stam 1999]. The original 1st-order semi-Lagrangian method

traces back a given node according to

φ(p,tₙ₊₁)=φ(p−Δtv(p,tₙ₊₁),tₙ), (5)

and uses trilinear interpolation to estimate the advected scalars.

While it is simple to implement and unconditionally stable, it produces severe numerical diffusion and dissipation [Fedkiw et al. 2001; Kim et al. 2008], because of the lack of accuracy. In the SRL framework, traditional trilinear interpolation is replaced with high-order polynomial reconstruction [Desjardins and Pitsch 2009]. It reduces numerical diffusion significantly compared to the original semi-Lagrangian method.

In contrast to the original semi-Lagrangian method (which is monotonic), high-order interpolation sometimes introduces a nonmonotonic solution. This new extremum may give rise to numerical instability [Selle et al. 2008]. To avoid such instabilities, we apply a simple limiting technique similar to that suggested by Selle et al. [2008]: when the interpolated result is larger/smaller than the maximum/minimum of the sub-grid values, we perform trilinear interpolation in the sub-grid. According to our experiments, such limiting is rarely required (below 1.5%), and hence has only a small impact on the overall accuracy.

### 3.3 Accurate Re-Distancing Algorithm

Re-distancing (i.e., re-initialization) is an essential step for accurate level set tracking. When interfaces are evolved via the advection process, it is almost impossible to maintain the signed distance property exactly. This inability to maintain the signed distance property usually degrades the overall accuracy of advection and the quality of geometric quantities such as normals and curvatures. In order to produce visually plausible fluid simulation, therefore, an accurate re-distancing algorithm is also required. Because of its importance, various re-distancing algorithms have been actively developed in CFD communities, including the fast marching method [Sethian 1995] and PDE-based methods [Peng et al. 1999; Osher and Fedkiw 2002].

In this invention, we present a high-order PDE-based re-distancing algorithm for a spectrally refined level set method. Compared to the mesh-based direct re-distancing algorithm [Desjardins and Pitsch 2009], PDE-based methods are more flexible to extend to high-order. The PDE-based re-distancing equation is given by

φₜ+S(φ₀)(|∇φ|−1)=0 (6)

where S(φ₀) is a sign function which takes one in positive regions, minus one in negative regions, and zero at the interface [Osher and Fedkiw 2002]. For accurate integration of Equation 6, the spatial derivative ∇φ needs to be computed with some precision.

In the adaptive or unstructured grid structure, however, an accurate high-order upwind method such as ENO or WENO is not efficiently performed compared to its performance in a regular grid [Wolf 2007; Cecil et al. 2008]. Because of the variable stencils, explicit formula for derivative computation does not exist in contrast to the regular grid structure [Osher and Fedkiw 2002]. Especially, the most popular adaptive data structure, the octree, has various types of variable stencils, making it difficult to provide explicit mathematical formulas for efficient computations.

In the SRL grid, however, the situation is slightly different. After the number of quadrature points is decided, because the stencil between two neighboring quadrature points is fixed, the computation of coefficients can be done as a pre-process. This reduces the run-time computation costs significantly, and makes it viable to employ ENO/WENO in the SRL grid as in the regular grid. During the re-initialization, high-order derivative computations are performed only in the narrow band that contains the sub-grid quadrature points (FIG. 1(b)). Outside of this band, simple 1st-order upwind method is used. Because the re-distancing process propagates information originating from the interface, limiting the high-order computation in the vicinity of the interface has little impact on the overall accuracy.

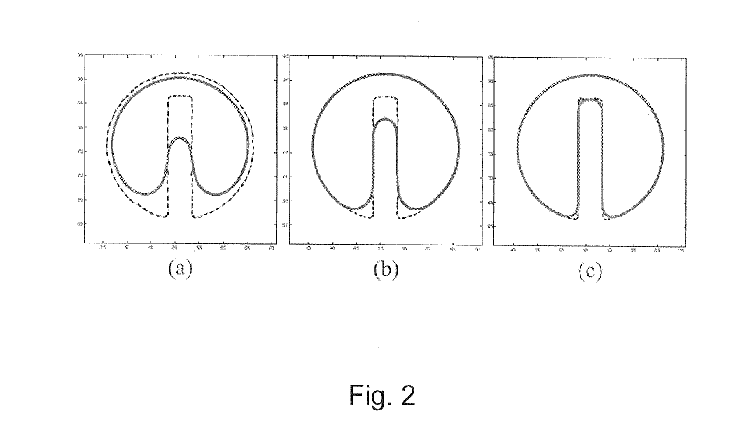

Compared to geometric algorithms such as the direct method based on an extracted mesh [Desjardins and Pitsch 2009] or the fast marching method [Sethian 1995], high-order PDE-based reinitialization has advantages in the aspect of preserving detailed interface structures as shown in FIG. 2. While the geometry based algorithms are hard to extend to high order, the PDE-based method is more flexible in this regard, requiring modifications only in the derivative computations. We provide a detailed derivation of 3rd-order WENO for variable stencils in Appendix A. A general framework for deriving WENO coefficients is presented by Chi-Shu [1997] and a detailed description about 5th-order variable WENO can be found in Wang et al. [2008]. In Appendix B, we make several revisions to the 5th-order variable WENO method of Wang et al. [2008]. (The revisions fix some errors in the original derivation.)

The suggested re-initialization framework is computationally more expensive than the coarse grid level re-initialization [Desjardins and Pitsch 2009]. However, the proposed framework can be easily parallelized due to its fully-Eulerian nature, and does not have to be performed as frequently as the advection process. In addition, because the coarse grid-level re-initialization can destroy sub-grid interfacial features, the more accurate re-initialization in the sub-grid structure achieved by the proposed method justifies the use of more computational resources.

Determining the optimal re-initialization frequency is an important issue for which, to date, no general solution has been proposed [Peng et al. 1999]. Too frequent re-initialization is known to be detrimental to the overall numerical accuracy. However, too infrequent re-initialization can incur some difficulties of maintaining the signed distance property. Actually, when we tested a 2D liquid simulation using the SRL framework, we observed that too infrequent re-initialization gave rise to some deterioration of the accuracy of the whole method. In the fluid scenes which have complex velocity fields, if the interface travels longer than 30 h without re-initialization, the signed distance property was hard to preserve even though the SRL has good advection accuracy.

Intuitively, we expect that a rapidly evolving interface can easily deviate from the signed distance function. Hence, we set up a simple policy based on Eulerian movements of the interface. When the interface evolves by Δt, the maximum Eulerian movements of the level set function with respect to the grid can be evaluated as Δt(|u|max/Δx+|v|max/Δy+|w|max/Δz) (i.e., CFL). If the accumulated Eulerian movement of the interface exceeds a user defined threshold t or the number of advections exceeds a, we perform re-initialization (We used 15 and 40 for the values of t and a, respectively).

### 4. Results

In all experiments reported in this section, we used a Legendre polynomial to determine the Gauss-Lobatto quadrature points, and used five for the number (N) of nodes for one axis. We employ 2nd-order Runge-Kutta method for backtracking of the semi-Lagrangian method. In addition, we successfully achieved significant speedups by parallelization using OpenMP directives; Our implementation achieved about x3.7 and x7.3 speedups for 4 and 8 processors, respectively. The test was performed on Dell Precision T5500 which is an oct-core machine. Due to the fully-Eulerian nature, the proposed framework is readily parallelizable and shows good scalability.

### 4.1 Rotation of a 3D Zalesak Sphere

For scientific evaluation of the mass conserving property, we performed 3D Zalesak sphere tests with effective resolution of 512³, which demonstrate that the sharp corners are preserved quite accurately. For quantitative comparison with the particle level set method, we also performed the Zalesak sphere test reported in [Enright et al. 2002a]. We used 100³ SRL grid with five quadrature points for one axis (i.e., it spends same order of memory resources compared to the particle level set method). The total volume change was below 0.01% with the proposed method. (The volume change was 2.3% with the particle level set method [Enright et al. 2002a]).

### 4.2 Comparison of Re-Initialization Accuracy

To compare the quality of the re-initialization methods, we created an artificial setup in which the re-distancing is performed at every time step while the object is advected in a given velocity field. So, the amount of numerical dissipation in the whole process is proportional to the number of advections and re-initializations. In all experiment, the triangle meshes (or line segments in 2D) used for direct re-initialization method are extracted from the refined grid.

We performed 2D Zalesak disk tests (five rotations with reinitialization at every time-step) as shown FIG. 2. While the direct re-distancing algorithm dissipates the original disk severely, the proposed method based on 5th-order variable WENO scheme preserves the shape well even after numerous re-initializations. In 3D, we set up an experiment which advects a bunny-shaped model in a rotational velocity field (with re-initialization at every timestep). While the mesh-based direct re-initialization method (which is 2nd-order accurate) lost 8.2% of their volume, the proposed reinitialization method based on 5th-order WENO scheme lost only 1.7% and preserves detailed features of the bunny better.

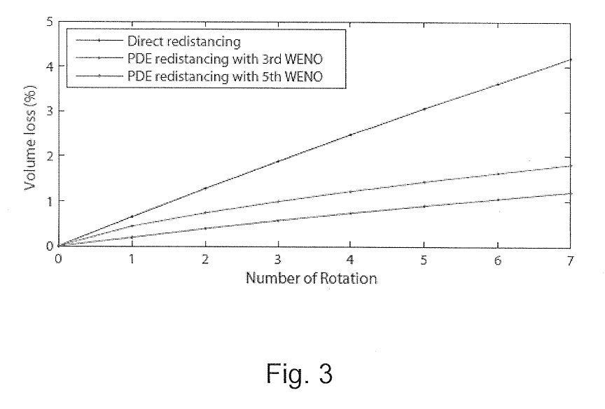

As we stated in Section 3.3, too frequent re-initialization is detrimental to the overall numerical accuracy. When we performed actual fluid simulations demonstrated in Section 4.3, we used the simple policy suggested in Section 3.3 to determine the re-initialization frequency. To estimate the amount of numerical diffusion caused by such infrequent re-initializations, we performed another experiment which rotates a bunny-shaped model using the suggested policy (We used 15 and 40 for the values of t and a, respectively). The PDE-based re-initialization method based on 5th-order WENO scheme lost their volume about 0.19% during one revolution, while the mesh-based direct re-initialization method lost 0.65%. The overall volume errors for each re-initialization method are shown in FIG. 3.

### 4.3 3D Fluid Simulations

We experimented the proposed interface tracking framework for liquid simulations, in which inviscid incompressible free-surface flow was used to model the liquid dynamics [Enright et al. 2002b]. We used 1st-order semi-Lagrangian method [Stam 1999] for velocity advection, and the ghost-fluid method [Enright et al. 2003] for projection and surface tensions. The velocity at the interface is extrapolated to the air region using the PDE-based extrapolation method [Peng et al. 1999]. A PDE-based re-distancing algorithm based on 5th-order variable WENO scheme is employed to reinitialize the level set.

Due to the fully-Eulerian nature, the proposed method captured complex liquid flows which experience lots of merging and splitting without any special treatment. Compared to conventional Eulerian methods, numerical diffusions are less noticeable. All demonstrations were performed on an Intel Core i7 940 2.93 GHz processor (which is a quad-core CPU) with 6 GB of memory. The time measurements reported in this section include the interface tracking and all the other steps of the fluid solver. The reported total computational time taken for fluid simulator, surface advection, and re-initialization were about 20%, 45% and 35% of the total computational time over the course of simulations, respectively. The numbers of simulation time-steps per one animation frame ( 1/30 sec) were about 6.8, 6.0 and 12.6, respectively. In our demonstrations, we put different CFL restrictions for fluid simulation and interface tracking (about 3.5 and 1.5, respectively). So, there are several interface tracking steps for every velocity update.

### 5. CONCLUSION

In this invention, we presented a new fully-Eulerian interface tracking framework for high-quality liquid simulation. In the absence of Lagrangian computational elements, the proposed framework could robustly handle topological changes without special treatments. To avoid numerical diffusion caused by 1st-order semi-Lagrangian method, we employed a pseudo-spectral representation of the level set function [Desjardins and Pitsch 2009] which provides a sub-grid description of the interface. To prevent destruction of the fine surface details during re-initialization, we proposed a high-order PDE-based re-initialization method [Osher and Fedkiw 2002] which is tailored to the spectrally refined grid structure. By reducing numerical diffusion in advection and re-initialization processes, detailed interfacial structures were preserved quite accurately. Despite of its fully-Eulerian nature, the suggested framework exhibited good mass conservation comparable to that achieved by existing Lagrangian-based surface tracking frameworks. Finally, the proposed method is suitable for parallel computing environments, which is becoming an attractive feature considering the ongoing development of more powerful parallel devices such as many-core processors [Seiler et al. 2008].

Our PDE-based re-distancing method is extremely accurate and is easily parallelized and extended to high-order. However, it is far more computationally expensive than other, less accurate techniques, such as the 1st-order fast marching method [Sethian 1995]. In our experiments, we have found the additional accuracy worth the cost. However, we have not done extensive experimentation with other techniques and, given that re-distancing isn't performed as frequently as advection, it may be the case that a faster and less accurate method will prove sufficient in practice, especially in sequential computing environments. Further investigation of redistancing methods in the context of the spectrally refined grid is an interesting area of future work.

Another possible avenue of future work would be to integrate the fully-Eulerian surface tracking framework with Lagrangian mass particles [Song et al. 2005]. Because of the inherent limitation of the grid, fluid or air features which are smaller than a grid size cannot be represented as a distance function. So, combining with Lagrangian mass particles can improve the visual quality of the animation. In addition, more detailed numerical properties of the spectrally refined grid are worth to investigate. The level set method usually exhibits 1st-order accuracy with topology changes because the interface simply merge regions together when they are smaller than a single grid spacing. Due to the variable-sized stencil, the widest grid spacing in the spectrally refined grid is about 1.309 times larger than that of a regular grid. So, the numerical accuracy can be degraded when topology changes are occurred. In addition, the amount of deterioration of the numerical accuracy near the stiff regions such as thin fluid features is also worth to investigate.

An aspect of the invention provides a method for tracking detail-preserving fully-Eulerian interface.

The method for tracking fully-Eulerian interface comprises steps of:

representing a liquid volume using a spectrally refined level set (SRL) surface represented by a level set function, wherein the SRL provides a plurality of fixed grid points near a phase interface of the liquid, and provides a predetermined number of sub-grid quadrature points (S100);

solving an advection equation for evolving the phase interface in time (S200);

transporting the level set function using a reconstructed high-order polynomials (S300);

re-distancing the level set function using a PDE-based re-distancing equation (S400); and displaying on a computer display a portion of the liquid volume including the phase interface represented by the transported level set (S500).

The sub-grid quadrature points may comprise Gauss-Lobatto quadrature points.

The number of the predetermined number of sub-grid quadrature points may comprise three (3), five (5), seven (7), and nine (9).

The phase interface may be evolved by a velocity field.

The level set function, φ, may be represented as a signed distance function such that |∇φ|=1 and the phase interface may be defined as φ=0.

The advection equation may be given by

φₜ+u·∇φ=0 (1)

The step (S100) for representing may comprise steps for:

constructing a high-order polynomial description of the level set function for each cell; and

determining interpolation weights for a given point using a classical Lagrange polynomial.

A multi-dimensional Lagrange interpolation may be performed by a dimensional splitting method.

The dimensional splitting method may be given by

$$\begin{matrix}{φ}_{i , j , k} ( x , y , z ) = {\sum }_{p = 0}^{N - 1} [ {w}^{p} ( {x}^{′} ) {\sum }_{q = 0}^{N - 1} [ {w}^{q} ( {y}^{′} ) {\sum }_{r = 0}^{N - 1} {w}^{r} ( {z}^{′} ) {φ}_{i , j , k}^{p , q , r} ] ] & ( 2 ) \\ ( {w}^{α} ( r ) = \frac{{\prod }_{β = 0 , β \neq α}^{N - 1} ( r - {r}_{β} )}{{\prod }_{β = 0 , β \neq α}^{N - 1} ( {r}_{α} - {r}_{β} )} ) & ( 3 ) \\ ( {x}^{′} = \frac{x - {x}_{i}}{{x}_{i + 1} - {x}_{i}} , {y}^{′} = \frac{y - {y}_{i}}{{y}_{i + 1} - {y}_{i}} , {z}^{′} = \frac{z - {z}_{i}}{{z}_{i + 1} - {z}_{i}} ) & ( 4 )\end{matrix}$$

The step for transporting may comprise a step for limiting the interpolation when the interpolated result is larger or smaller than a maximum or minimum of sub-grid values.

The PDE-based re-distancing equation may be given by

φₜ+S(φ₀)(|∇φ|−1)=0 (6)

The step for re-distancing may comprise a step for performing high-order derivative computations are performed only in a narrow band that contains the sub-grid quadrature points.

Outside of the narrow, a band simple first-order upwind method may be used.

### REFERENCES

BARGTEIL, A. W., GOKTEKIN, T. G., O′BRIEN, J. F., AND STRAIN, J. A. 2006. A semi-lagrangian contouring method for fluid simulation. ACM Trans. Graph. 25, 1, 19-38.
BROCHU, T., AND BRIDSON, R. 2009. Robust topological operations for dynamic explicit surfaces. SIAM J. Sci. Comput. 31, 4, 2472-2493.
CECIL, T. C., OSHER, S. J., AND QIAN, J. 2008. Essentially nonoscillatory adaptive tree methods. J. Sci. Comput. 35, 1, 25-41.
CHENTANEZ, N., FELDMAN, B. E., LABELLE, F., O′BRIEN, J. F., AND SHEWCHUK, J. R. 2007. Liquid simulation on lattice-based tetrahedral meshes. In SCA '07: Proceedings of the 2007 ACM SIGGRAPH/Eurographics symposium on Computer animation, 219-228.
CHI-SHU, W. 1997. Essentially non-oscillatory and weighted essentially non-oscillatory schemes for hyperbolic conservation laws. Tech. rep.
DESJARDINS, O., AND PITSCH, H. 2009. A spectrally refined interface approach for simulating multiphase flows. J. Comput. Phys. 228, 5, 1658-1677.
ENRIGHT, D., FEDKIW, R., FERZIGER, J., AND MITCHELL, I. 2002. A hybrid particle level set method for improved interface capturing. J. Comp. Phys. 183, 83-116.
ENRIGHT, D., MARSCHNER, S., AND FEDKIW, R. 2002. Animation and rendering of complex water surfaces. ACM Trans. Graph. 21, 3, 736-744.
ENRIGHT, D., NGUYEN, D., GIBOU, F., AND FEDKIW, R. 2003. Using the particle level set method and a second order accurate pressure boundary condition for free surface flows. In In Proc. 4th ASME-JSME Joint Fluids Eng. Conf., number FEDSM2003-45144. ASME, 1-6.
FEDKIW, R., STAM, J., AND JENSEN, H. W. 2001. Visual simulation of smoke. Computer Graphics (Proc. ACM SIGGRAPH 2001) 35, 15-22.
GUEYFFIER, D., LI, J., NADIM, A., SCARDOVELLI, R., AND ZALESKI, S. 1999. Volume-of-fluid interface tracking with smoothed surface stress methods for three-dimensional flows. J. Comput. Phys. 152, 2, 423-456.
HOUSTON, B., NIELSEN, M. B., BATTY, C., NILSSON, O., AND MUSETH, K. 2006. Hierarchical rle level set: A compact and versatile deformable surface representation. ACM Trans. Graph. 25, 1, 151-175.
KIM, D., SONG, O.-Y., AND KO, H. -S. 2008. A semi-lagrangian cip fluid solver without dimensional splitting. Computer Graphics Forum 27, 2, 467-475.
KIM, D., SONG, O.-Y., AND KO, H. -S. 2009. Stretching and wiggling liquids. ACM Trans. Graph. 28, 5, 1-7.
LOSASSO, F., GIBOU, F., AND FEDKIW, R. 2004. Simulating water and smoke with an octree data structure. ACM Trans. Graph. 23, 3, 457-462.
LOSASSO, F., SHINAR, T., SELLE, A., AND FEDKIW, R. 2006. Multiple interacting liquids. ACM Trans. Graph. 25, 3, 812-819.
MARCHANDISE, E., AND REMACLE, J. -F. 2006. A stabilized finite element method using a discontinuous level set approach for solving two phase incompressible flows. J. Comput. Phys. 219, 2, 780-800.
MIHALEF, V., METAXAS, D., AND SUSSMAN, M. 2007. Textured liquids based on the marker level set. Comput. Graph. Forum 26, 3, 457-466.
M″ULLER, M. 2009. Fast and robust tracking of fluid surfaces, In SCA '09: Proceedings of the 2009 ACM SIGGRAPH/Eurographics Symposium on Computer Animation, ACM, New York, N.Y., USA, 237-245.
OSHER, S., AND FEDKIW, R. 2002. The Level Set Method and Dynamic Implicit Surfaces. Springer-Verlag, New York.
OSHER, S., AND SETHIAN, J. A. 1988. Fronts propagating with curvature-dependent speed: Algorithms based on hamilton-jacobi formulations. J. Comp. Phys. 79, 12-49.
PENG, D., MERRIMAN, B., OSHER, S., ZHAO, H., AND KANG, M. 1999. A pde-based fast local level set method. J. Comput. Phys. 155, 2, 410-438.
PRESS, W. H., TEUKOLSKY, S. A., VETTERLING, W. T., AND FLANNERY, B. P. 2007. Numerical Recipes 3rd Edition: The Art of Scientific Computing. Cambridge University Press, New York, N.Y., USA.
RASMUSSEN, N., ENRIGHT, D., NGUYEN, D., MARINO, S., SUMNER, N., GEIGER, W., HOON, S., AND FEDKIW, R. 2004. Directable photorealistic liquids. In SCA '04: Proceedings of the 2004 ACM SIGGRAPH/Eurographics symposium on Computer animation, Eurographics Association, Aire-la-Ville, Switzerland, Switzerland, 193-202.
SEILER, L., CARMEAN, D., SPRANGLE, E., FORSYTH, T., ABRASH, M., DUBEY, P., JUNKINS, S., LAKE, A., SUGER-MAN, J., CAVIN, R., ESPASA, R., GROCHOWSKI, E., JUAN, T., AND HANRAHAN, P. 2008. Larrabee: a many-core x86 architecture for visual computing. ACM Trans. Graph. 27, 3, 1-15.
SELLE, A., FEDKIW, R., KIM, B., LIU, Y., AND ROSSIGNAC, J. 2008. An unconditionally stable maccormack method. J. Sci. Comput. 35, 2-3, 350-371.
SETHIAN, J. A. 1995. A fast marching level set method for monotonically advancing fronts. In Proc. Nat. Acad. Sci, 1591-1595.
SETHIAN, J. 1999. Level Set Methods and Fast Marching Methods. Cambridge University Press.
SONG, O.-Y., SHIN, H., AND KO, H. -S. 2005. Stable but non-dissipative water. ACM Trans. Graph. 24, 1, 81-97.
STAN, J. 1999. Stable fluids. Computer Graphics (Proc. ACM SIGGRAPH '99) 33, Annual Conference Series, 121-128.
SUSSMAN, M., AND HUSSAINI, M. Y. 2003. A discontinuous spectral element method for the level set equation. J. Sci. Comput. 19, 1-3, 479-500.
WANG, R., FENG, H., AND SPITERI, R. J. 2008. Observations on the fifth-order weno method with non-uniform meshes. Applied Mathematics and Computation 196, 433-447.
WANG, Z., YANG, J., AND STERN, F. 2009. An improved particle correction procedure for the particle level set method. J. Comp. Phys. 228, 16, 5819-5837.
WOJTAN, C., TH″UREY, N., GROSS, M., AND TURK, G. 2009. Deforming meshes that split and merge. ACM Trans. Graph. 28, 3, 1-10.
WOJTAN, C., TH″UREY, N., GROSS, M., AND TURK, G. 2010. Physics-inspired topology changes for thin fluid features. ACM Trans. Graph. 29, 4, 1-8.
WOLF, W. R, A. J. L. F. 2007. High-order eno and weno schemes for unstructured grids. Int. J. Numer. Meth. Fluids. 55, 10, 917-943.

What is claimed is:

1. A method for tracking fully-Eulerian interface, the method comprising steps of:
representing a liquid volume using a spectrally refined level set (SRL) surface represented by a level set function, wherein the SRL provides a plurality of fixed grid points near a phase interface of the liquid, and provides a predetermined number of sub-grid quadrature points;
solving an advection equation for evolving the phase interface in time;
transporting the level set function using a reconstructed high-order polynomials;
re-distancing the level set function using a PDE-based re-distancing equation; and
displaying on a computer display a portion of the liquid volume including the phase interface represented by the transported level set.

2. The method of claim 1, wherein the sub-grid quadrature points comprise Gauss-Lobatto quadrature points.

3. The method of claim 2, wherein the number of the predetermined number of sub-grid quadrature points comprises three (3), five (5), seven (7), and nine (9).

4. The method of claim 2, wherein the phase interface is evolved by a velocity field.

5. The method of claim 4, wherein the level set function, φ, is represented as a signed distance function such that |∇φ|=1 and the phase interface is defined as φ=0.

6. The method of claim 5, wherein the advection equation is given by
φₜ+u·∇φ=0 (1)

7. The method of claim 6, wherein the step for representing comprises steps for:
constructing a high-order polynomial description of the level set function for each cell; and
determining interpolation weights for a given point using a classical Lagrange polynomial.

8. The method of claim 7, wherein a multi-dimensional Lagrange interpolation is performed by a dimensional splitting method.

9. The method of claim 8, wherein the dimensional splitting method is given by
$$\begin{matrix}{φ}_{i , j , k} ( x , y , z ) = {\sum }_{p = 0}^{N - 1} [ {w}^{p} ( {x}^{′} ) {\sum }_{q = 0}^{N - 1} [ {w}^{q} ( {y}^{′} ) {\sum }_{r = 0}^{N - 1} {w}^{r} ( {z}^{′} ) {φ}_{i , j , k}^{p , q , r} ] ] & ( 2 ) \\ ( {w}^{α} ( r ) = \frac{{\prod }_{β = 0 , β \neq α}^{N - 1} ( r - {r}_{β} )}{{\prod }_{β = 0 , β \neq α}^{N - 1} ( {r}_{α} - {r}_{β} )} ) & ( 3 ) \\ ( {x}^{′} = \frac{x - {x}_{i}}{{x}_{i + 1} - {x}_{i}} , {y}^{′} = \frac{y - {y}_{i}}{{y}_{i + 1} - {y}_{i}} , {z}^{′} = \frac{z - {z}_{i}}{{z}_{i + 1} - {z}_{i}} ) & ( 4 )\end{matrix}$$

10. The method of claim 7, wherein the step for transporting comprises a step for limiting the interpolation when the interpolated result is larger or smaller than a maximum or minimum of sub-grid values.

11. The method of claim 7, wherein the PDE-based re-distancing equation is given by
φₜ+S(φ₀)(|∇φ|−1)=0 (6)

12. The method of claim 11, wherein the step for re-distancing comprises a step for performing high-order derivative computations are performed only in a narrow band that contains the sub-grid quadrature points.

13. The method of claim 12, wherein outside of the narrow a band simple first-order upwind method is used.
